(19) United States
(12) Patent Application Publication
(10) Pub. No.: US 2024/0406924 A1
(43) Pub. Date: Dec. 5, 2024

(54) USER EQUIPMENT CONTENTION-BASED POSITIONING WITHOUT AUTHENTICATION

(71) Applicant: Nokia Technologies Oy, Espoo (FI)

(72) Inventors: Nuno Manuel KIILERICH PRATAS, Aalborg (DK); Oana-Elena BARBU, Aalborg (DK); Johannes HARREBEK, Aalborg (DK); Benny VEJLGAARD, Aalborg (DK); Ryan KEATING, Naperville, IL (US); Frank FREDERIKSEN, Aalborg (DK)

(21) Appl. No.: 18/697,348

(22) PCT Filed: Oct. 1, 2021
(86) PCT No.: PCT/US2021/053215

§ 371 Date: Mar. 29, 2024

(51) Int. Cl. H04W 64/00

(52) U.S. Cl. CPC H04W 64/003

(57) ABSTRACT

Systems, methods, apparatuses, and computer program products for contention-based positioning without requiring device authentication are provided. For example, a method can include sending, by a user equipment, a positioning message to a serving network element in a network that includes multiple network elements including both the serving network element itself and at least one other network element. The positioning message can be sent as a contention-based message. The method can also include receiving, by the user equipment, a positioning response from the serving network element. Content of the positioning response can be contingent on a collision result of the contention-based message.

### FIELD

Some example embodiments may generally relate to communications including mobile or wireless telecommunication systems, such as Long Term Evolution (LTE) or fifth generation (5G) radio access technology or new radio (NR) access technology, or other communications systems. For example, certain example embodiments may generally relate to systems and/or methods for providing contention-based positioning to user equipment without requiring device authentication.

### BACKGROUND

Examples of mobile or wireless telecommunication systems may include the Universal Mobile Telecommunications System (UMTS) Terrestrial Radio Access Network (UTRAN), Long Term Evolution (LTE) Evolved UTRAN (E-UTRAN), LTE-Advanced (LTE-A), MulteFire, LTE-A Pro, and/or fifth generation (5G) radio access technology or new radio (NR) access technology. 5G wireless systems refer to the next generation (NG) of radio systems and network architecture. A 5G system is mostly built on a 5G new radio (NR), but a 5G (or NG) network can also build on the E-UTRA radio. It is estimated that NR provides bitrates on the order of 10-20 Gbit/s or higher, and can support at least service categories such as enhanced mobile broadband (eMBB) and ultra-reliable low-latency-communication (URLLC) as well as massive machine type communication (mMTC). NR is expected to deliver extreme broadband and ultra-robust, low latency connectivity and massive networking to support the Internet of Things (IoT). With IoT and machine-to-machine (M2M) communication becoming more widespread, there will be a growing need for networks that meet the needs of lower power, low data rate, and long battery life. The next generation radio access network (NG-RAN) represents the RAN for 5G, which can provide both NR and LTE (and LTE-Advanced) radio accesses. It is noted that, in 5G, the nodes that can provide radio access functionality to a user equipment (i.e., similar to the Node B, NB, in UTRAN or the evolved NB, eNB, in LTE) may be named next-generation NB (gNB) when built on NR radio and may be named next-generation eNB (NG-eNB) when built on E-UTRA radio.

### SUMMARY

An embodiment may be directed to an apparatus that may include at least one processor and at least one memory comprising computer program code. The at least one memory and computer program code can be configured, with the at least one processor, to cause the apparatus at least to perform a process. The process can include sending a positioning message to a serving network element in a network that includes multiple network elements including both the serving network element itself and at least one other network element. The positioning message can be sent as a contention-based message. The process can also include receiving a positioning response from the serving network element. Content of the positioning response can be contingent on a collision result of the contention-based message.

An embodiment may be directed to an apparatus that may include at least one processor and at least one memory comprising computer program code. The at least one memory and computer program code can be configured, with the at least one processor, to cause the apparatus at least to perform a process. The process can include receiving from a user equipment a positioning message at a serving network element in a network that includes multiple network elements including both the serving network element itself and at least one other network element. The positioning message can be received as a contention-based message. The process can also include sending a positioning response from the serving network element. Content of the positioning response can be contingent on a collision result of the contention-based message.

An embodiment may be directed to a method that can include sending, by a user equipment, a positioning message to a serving network element in a network that includes multiple network elements including both the serving network element itself and at least one other network element. The positioning message can be sent as a contention-based message. The method can also include receiving, by the user equipment, a positioning response from the serving network element. Content of the positioning response can be contingent on a collision result of the contention-based message.

An embodiment may be directed to a method that can include receiving from a user equipment a positioning message at a serving network element in a network that includes multiple network elements including both the serving network element itself and at least one other network element. The positioning message can be received as a contention-based message. The method may also include sending a positioning response from the serving network element. Content of the positioning response can be contingent on a collision result of the contention-based message.

An embodiment may be directed to an apparatus that can include means for sending a positioning message to a serving network element in a network that includes multiple network elements including both the serving network element itself and at least one other network element. The positioning message can be sent as a contention-based message. The apparatus may also include means for receiving a positioning response from the serving network element. Content of the positioning response can be contingent on a collision result of the contention-based message.

An embodiment may be directed to an apparatus that can include means for receiving from a user equipment a positioning message at a serving network element in a network that includes multiple network elements including both the serving network element itself and at least one other network element. The positioning message can be received as a contention-based message. The apparatus can also include means for sending a positioning response from the serving network element. Content of the positioning response can be contingent on a collision result of the contention-based message.

### BRIEF DESCRIPTION OF THE DRAWINGS

For proper understanding of example embodiments, reference should be made to the accompanying drawings, wherein:

FIG. 1 illustrates an asset tracking scenario;

FIG. 2 illustrates an overview of uplink time difference of arrival;

FIG. 3 illustrates new radio lite, as compared with other approaches;

FIG. 4 illustrates an uplink-based positioning procedure in new radio;

FIG. 5 illustrates a contention-based physical random access channel procedure for uplink localization, according to certain embodiments;

FIG. 6 illustrates two embodiments of a contention-based procedure for uplink localization, according to certain embodiments;

FIG. 7A illustrates assignment of restricted contention based access resources in one example, according to certain embodiments;

FIG. 7B illustrates assignment of restricted contention based access resources in another example, according to certain embodiments;

FIG. 7C illustrates assignment of restricted contention based access resources in a further example, according to certain embodiments;

FIG. 8 illustrates approaches to mapping collided preambles to the resources;

FIG. 9 illustrates an example flow diagram of a method, according to an embodiment;

FIG. 10 illustrates another example flow diagram of a method, according to an embodiment;

FIG. 11A illustrates an example block diagram of an apparatus, according to an embodiment; and

FIG. 11B illustrates an example block diagram of an apparatus, according to an embodiment.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for providing contention-based positioning without requiring device authentication for a user equipment (UE), is not intended to limit the scope of certain embodiments but is representative of selected example embodiments.

The features, structures, or characteristics of example embodiments described throughout this specification may be combined in any suitable manner in one or more example embodiments. For example, the usage of the phrases “certain embodiments,” “some embodiments,” or other similar language, throughout this specification refers to the fact that a particular feature, structure, or characteristic described in connection with an embodiment may be included in at least one embodiment. Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more example embodiments.

Certain embodiments may have various aspects and features. These aspects and features may be applied alone or in any desired combination with one another. Other features, procedures, and elements may also be applied in combination with some or all of the aspects and features disclosed herein.

Additionally, if desired, the different functions or procedures discussed below may be performed in a different order and/or concurrently with each other. Furthermore, if desired, one or more of the described functions or procedures may be optional or may be combined. As such, the following description should be considered as illustrative of the principles and teachings of certain example embodiments, and not in limitation thereof.

Low cost assets tracking may be applicable to various communication standards. For example, there may be benefit to the support of accurate positioning in reduced complexity devices, sometimes referred to as new radio (NR) lite.

Assets tracking may aim to provide accurate location of low cost and low power tags. A global working solution may be designed to cover diverse scenarios ranging from remote rural areas, urban outdoor areas, and indoor areas, including homes, offices, and large factories. The requirements for assets tracking positioning accuracy may vary. For example, users may require less strict accuracy for items that are in commute on highways or at sea, while requiring higher positioning accuracy for items in denser areas such as factories and storage/delivery facilities.

Furthermore, at least two types of asset tracking use cases may be supported. In a first use case, the request may come from the network side due to an asset application request. For example, a user may want to identify where a particular package is. In a second use case, the device itself may trigger the positioning procedure. This later use case can be further divided into two sub-cases of use, which are designated (i) and (ii) for convenience only. In sub-case (i), the device may want to know its own position but may not need to share the device's position with the network/application. In sub-case (ii), the case the device may share the device's position with the network or an application. While in (ii) there may be a need to authenticate the UE towards the network, this may not be the case for (i), as the network does not need the device identity. Examples of sub-case (i) may include shipping containers whose doors only open if the containers are at specific positions, such as at a source warehouse and a destination warehouse. An example of sub-case (ii) may be location tracking updates of at least one of these shipping containers towards their controlling application. Certain embodiments discussed herein may be particularly beneficial to use sub-case (i), but should not be considered to be limited thereto.

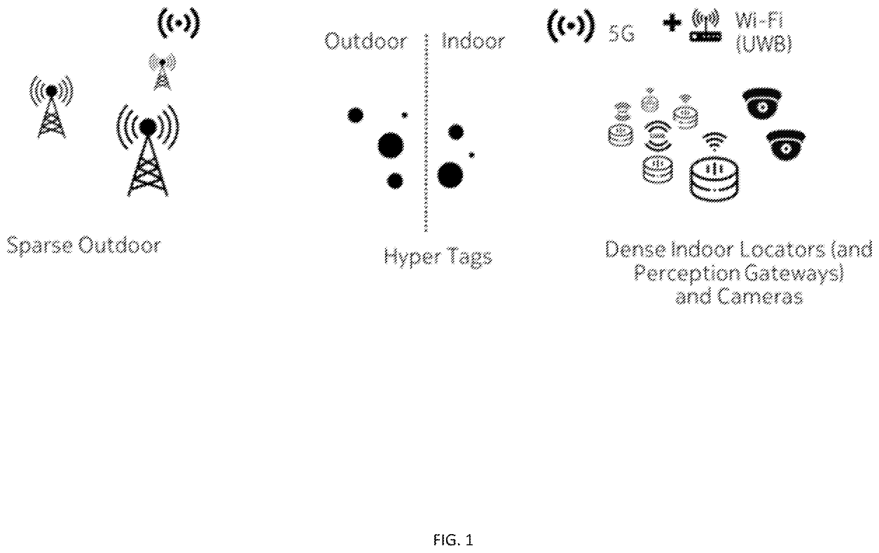

FIG. 1 illustrates an asset tracking scenario. The illustrated scenario can include an outdoor environment and an indoor environment. As shown in FIG. 1, hyper tags may provide localization of assets without requiring massive scale ecosystem deployment. Outdoors, tags can be localized through a public cellular network, providing global coverage and accuracy of about 10 to 20 meters without dedicated equipment. Once in an indoor environment, these tags can be located using densely deployed infrastructure locators and flexible perception gateways, offering accuracy of within one to two meters. Furthermore, the tags can provide an infrared (IR) beacon feature that allows infrastructure camera-based algorithms and systems to enhance localization.

In order to allow tracking of handling and storage conditions, hyper tags may maintain a motion vector, an ambience vector, and a co-presence vector using an onboard accelerometer, temperature sensor, and humidity sensor. These vectors can be offloaded periodically to the perception gateways in an energy-efficient way.

New radio (NR) of the Third Generation Partnership Project (3GPP) may provide for native positioning support. Native positioning support may rely on a variety of parameters, such as downlink (DL) time difference of arrival (TDOA), uplink (UL) TDOA, DL angle of departure (AoD), UL angle of arrival (AoA), and multi-cell round trip time (Multi-RTT). These and other parameters may take advantage of various signals. For example, in the DL, a positioning reference signal (PRS) may be provided and, in the UL, a sounding reference signal (SRS) for positioning (SRS-P) may be provided.

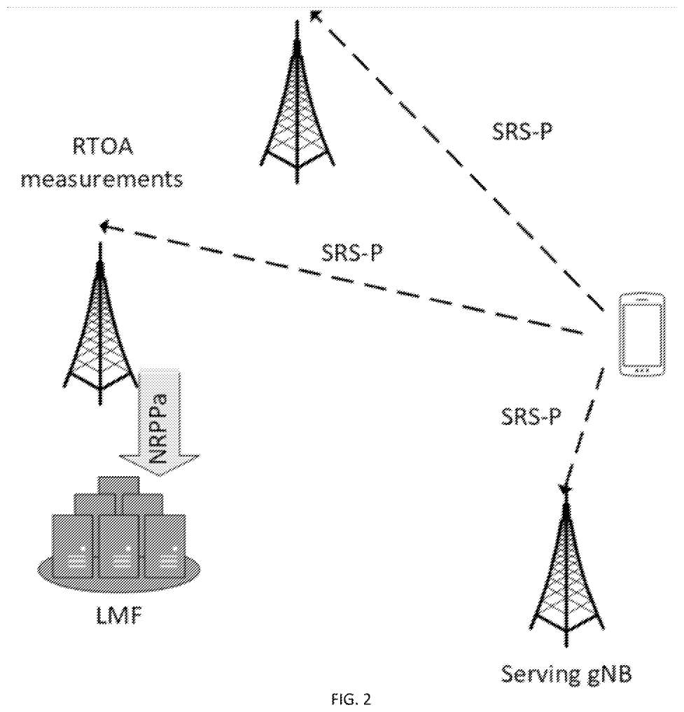

FIG. 2 illustrates an overview of uplink time difference of arrival. UL-TDOA is one method for positioning support that may rely on UL measurements/signals. In this approach, UEs may transmit an SRS-P signal to the next generation Node Bs (gNBs). The gNBs can measure the relative time of arrival (RTOA) based on the SRS-P from the UE. The measurements can be reported to a location management function (LMF), which can then estimate the position of the UE. The gNBs can report measurements using New Radio Positioning Protocol A (NRPPa) or another protocol.

Positioning can take place during radio resource control (RRC) inactive state or RRC idle state. Any uplink location services (LCS) or Long Term Evolution (LTE) positioning protocol (LPP) message can be transported in RRC_INACTIVE. If there is a UE-initiated data transmission using UL small data transmission (SDT), the network can send a DL LCS, LPP message and/or RRC message to the UE. Such a message to the UE may be used, for example, to configure SRS if UL positioning supported.

If the UE did not initiate UL SDT, the network may transition the UE to RRC_CONNECTED, for example based on radio access network (RAN) paging.

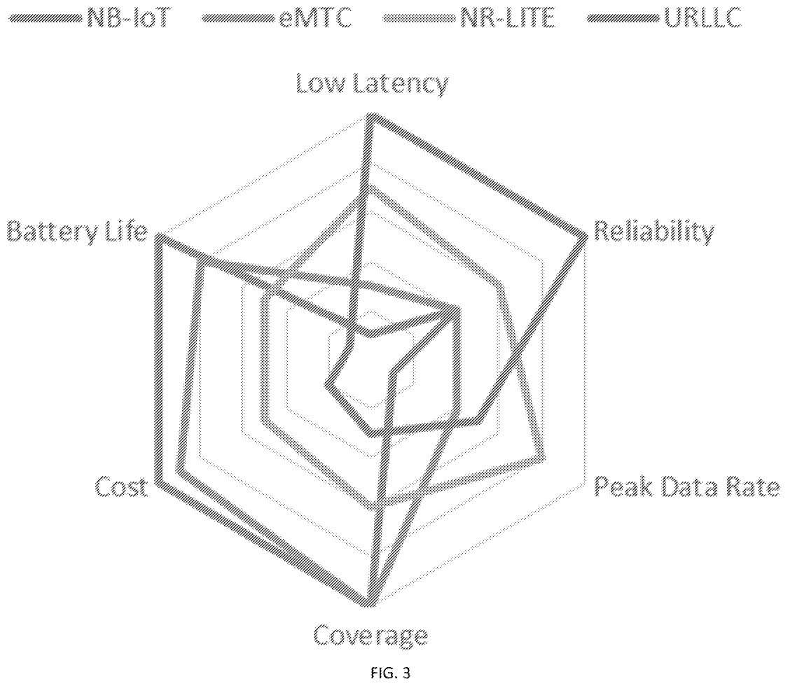

FIG. 3 illustrates new radio lite, as compared with other approaches. As shown in FIG. 3, NR lite may address use cases with internet of things (IoT)-type requirements that cannot be met by enhanced machine type communication (eMTC), narrow band IoT (NB-IoT), or ultra-reliable low latency communications (URLLC). Such uses cases may involve, for example, low-complexity, enhanced coverage, long battery life, and massive number of devices. NR lite may support data rates of ten to one hundred mega-bits per second (Mbps). Such a data rate may be useful for live video feeds, visual production control, and process automation. NR lite may support a latency of about 10 to 30 ms. Such a latency may be useful for remote drone operation, cooperative farm machinery, time-critical sensing, and feedback, and remove vehicle operation. NR lite may support a positioning accuracy of 30 cm to 1 meter, which may be useful for indoor asset tracking, coordinated vehicle control, or remote monitoring. Furthermore, NR lite may have a coverage enhancement of about 10 to 15 dB compared to enhanced mobile broadband (eMBB) and may permit a two- to four-times longer battery life for devices compared with eMBB.

NR lite features may include reduced bandwidth operation, complexity reduction techniques, coverage and reliability enhancements, device to device (D2D) communication, early data transmission, wake-up signal in idle mode, and grant-free transmission.

In the case of asset tracking, devices being tracked may have low complexity and limited battery capacity. As such, these types of devices may spend the majority of their lifetime in low energy expenditure states such as RRC Idle or Inactive. NR positioning procedures may not be suitable for this type of application, for example due to being designed for operation in RRC Connected and consequently having significant signaling overhead associated with the transition from RRC Idle/Inactive to RRC Connected.

Furthermore, there can be use cases where the device needs to know its own location, but does not necessarily need to report this location back to the network. In this case, device authentication would not be needed. Device authentication is one source of positioning procedure signaling overhead and as such the associated positioning procedure could be greatly simplified for devices in either RRC Idle or Inactive.

In DL-based positioning, a device may collect the PRSs transmitted from the surrounding transmission reception points (TRPs) and then, based on these signals and information about the position of at least one of these TRPs, derive the device position. However, this procedure can be quite signal processing intensive as some of these TRPs can be non-line of sight (NLoS) and may introduce errors based on line of sight (LoS) assumptions. One way to overcome this, albeit at the cost of additional signaling processing, is for the device to perform several iterations of this procedure where the TRPs in NLoS are identified and excluded from the set used for positioning.

In UL-based positioning, this signal processing can be offloaded to the network. One approach to implement UL-based positioning is for the device to transmit dedicated SRS-Ps. For this to be possible, the device may first be configured to transmit these SRS-Ps, which may involve significant signaling overhead. Another approach would be to use the physical random access channel (PRACH) structure/procedure to enable UL based positioning.

In order to avoid the signaling overhead associated with dedicated resource reservation, the access to these localization PRACH resources may be contention based. However, the some UL-based positioning procedures may assume that there is a single UE performing UL transmissions. Therefore, certain embodiments provide a procedure that can cope with the occurrence of collisions/contention.

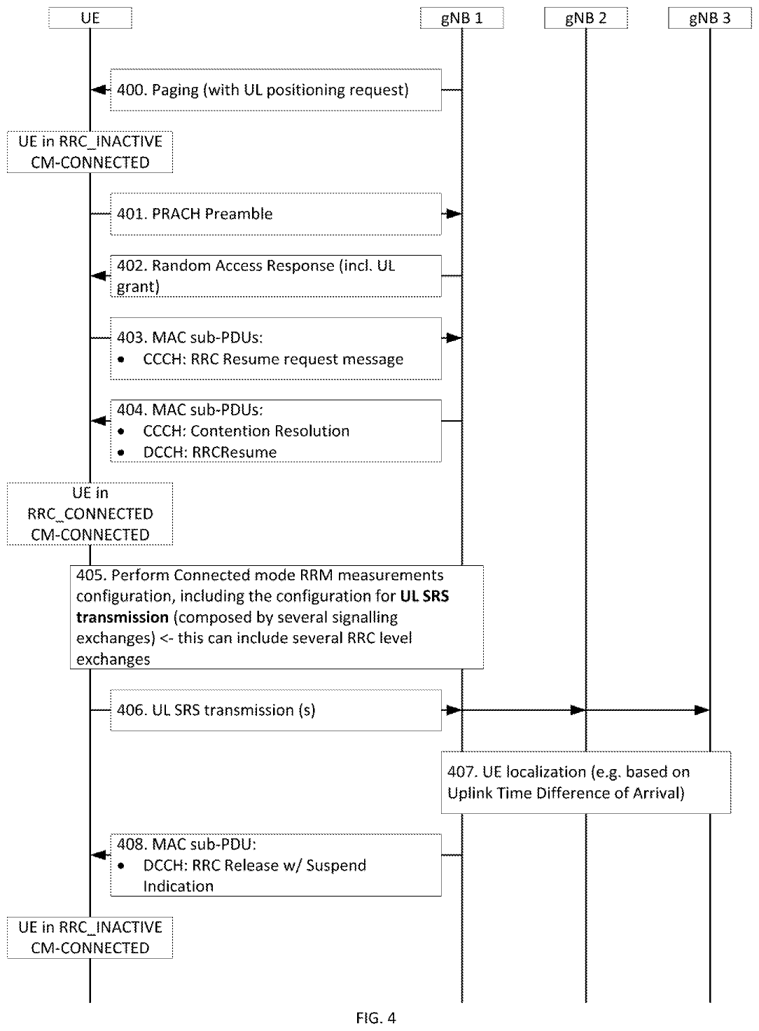

FIG. 4 illustrates an uplink-based positioning procedure in new radio. More particularly, FIG. 4 relates an UL-based positioning procedure in RRC Connected. The main procedures of such an uplink-based positioning may include the following: paging of the device, which may assume network/application triggered positioning (procedure 400); PRACH procedure (procedures 401, 402, 403, and 404); UE transition to RRC connected mode (procedures 403, 404, and 405), UE configuration for UL SRS transmission (procedure 405); UL SRS transmission (procedure 406); UE localization at the LMF (procedure 407); and UE transition to RRC idle/inactive (procedure 408). Other procedures can also be employed, with the illustrated procedures serving as examples.

The use of PRACH for acquiring the distance of the UE towards the serving TRP as part of the 2-step/4-step RACH procedure can enable the network (NW) to provide the timing advance to the UE as part of the RACH procedure in the MsgB/Msg2 payload. However, in certain embodiments a new P-PRACH may be provided, which may be applicable across multiple cells/TRPs and certain embodiments may provide a multi-cell/TRP procedure.

One approach to reduce the occurrence of collisions is to increase the contention space in contention based random access (CBRA). In the case of 2-step RACH, this increase in contention space can be achieved by increasing the number of available PRACH occasions (ROs) and physical uplink shared channel (PUSCH) occasions (POs), while in 4-step RACH the available ROs may be increased. In order to maximize the resource use efficiency, the ROs and POs resources may be allocated based on a target system load.

From a procedure point of view, a mechanism to deal with collisions when detected is for the affected UEs to back-off and attempt a new retransmission attempt at a later time. This approach incurs additional delay.

Certain embodiments provide an UL positioning procedure for devices in RRC Idle/Inactive, where the devices can acquire their own positioning without having dedicated resources and/or without authenticating themselves towards the network. The first aspect, namely acquiring their own positioning without having dedicated resources, may be accomplished through a contention-based access to the positioning resources. This contention-based access may avoid the need for dedicated resource allocation for at least one UE, and may provide recovery mechanisms when a contention does occur. The second aspect, namely avoiding the need for authentication to the network, can be due to a specific use case, such as sub-case (ii) discussed above. In such a case, the device may need to acquire the device's own position and may not necessarily need to inform the network/application of the device's position. Thus, the devices may not need to exchange any identity information with the network.

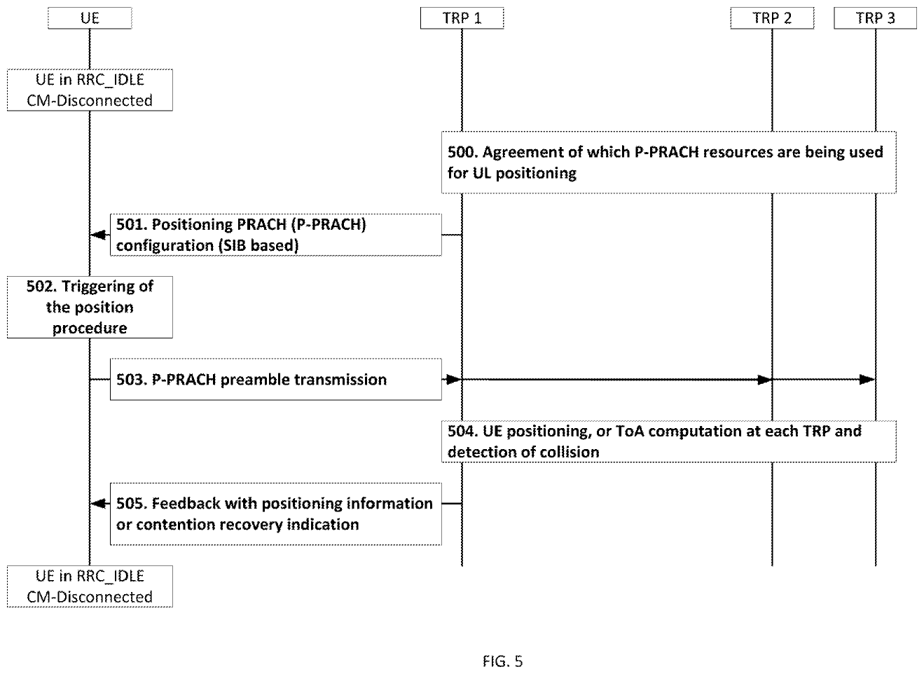

FIG. 5 illustrates a contention-based physical random access channel procedure for uplink localization, according to certain embodiments. FIG. 5 more particularly illustrates a PRACH procedure that can be performed between a UE device and a plurality of TRPs, which may be network elements, such as gNBs or the like.

Initially, the UE may be in RRC_IDLE state with a connection mode (CM) of disconnected. There may be, at 500, an agreement among the TRPs of common PRACH resources and individual spatial resources to be used for positioning purposes, including for example P-PRACH. This agreement can be made directly between the TRPs or it can be mediated/triggered by a core network entity, such as the LMF (not illustrated in FIG. 5).

The agreement at 500 can be made based on, when available, a target UE coarse location (for example, last known location, serving beam index, timing advance (TA), or the like), the traffic load, cell sizes, and so on. If UE coarse location is not available, then as a fallback the TRPs within a selected threshold distance from a target location (where a hypothetical UE may be camped) can be selected by the LMF.

During the process of agreement at 500, the TRPs may select their own receiver beams. For example, the TRPs may generate a list of beams that are likely to point in the direction of the target UE or a target location. For example, the TRPs can be configured to light up the sector towards the target UE/location at substantially the same time. For example, the sector light-up may occur at overlapping times or at times that are within a few millisecond of one another.

At 501, the TRPs can share the P-PRACH information with the devices camped within their coverage, including which TRPs are involved in the positioning procedure. In certain cases, the TRPs may also share the positioning of the TRPs involved in the positioning procedure. The P-RACH information can be shared in the cell via a new information element in the system information block (SIB). The sharing of the P-RACH information can be mediated by the LMF across the TRPs. This may help to ensure that the TRPs acquiring a positioning request from a target area are sharing substantially the same P-RACH information. For example, the P-RACH information may be shared in whole or in part.

At 502, the UE can be triggered to initiate the P-PRACH positioning procedure. The triggering can be internal to the UE application. For example, the triggering be an aperiodic or periodic polling of positioning data by the application layer. As another alternative, the triggering can be by NW paging request. These alternatives can be used individually or in combination with one another.

At 503, the device can perform the P-PRACH preamble transmission with enough transmission (Tx) power such that it reaches the TRPs identified in the message provided at 502. The Tx power can be determined by applying open loop power control to the weakest received synchronization signal block (SSB) from the identified TRPs.

At 504, the serving TRP can collect the positioning measurements, such as the time of arrival information, from the involved TRPs. In one example, the TRP or a core network entity, such as the LMF or edge LMF, can perform the positioning computations.

At 505, the serving TRP can provide feedback to the device as to the device's positioning. When no collision was detected, in one example, the feedback information can include the device position, while in another example, the time of arrival information can be given to the device, which can then use that time of arrival information to compute the device's own position. When collision is detected by the TRPs, a collision resolution procedure may allow the involved UEs to recover from the collision.

The UL positioning procedure illustrated in FIG. 5 may be configured with a framework associated with PRACH design. Nevertheless, other resources, such as contention-based SRS-P resources, could be used.

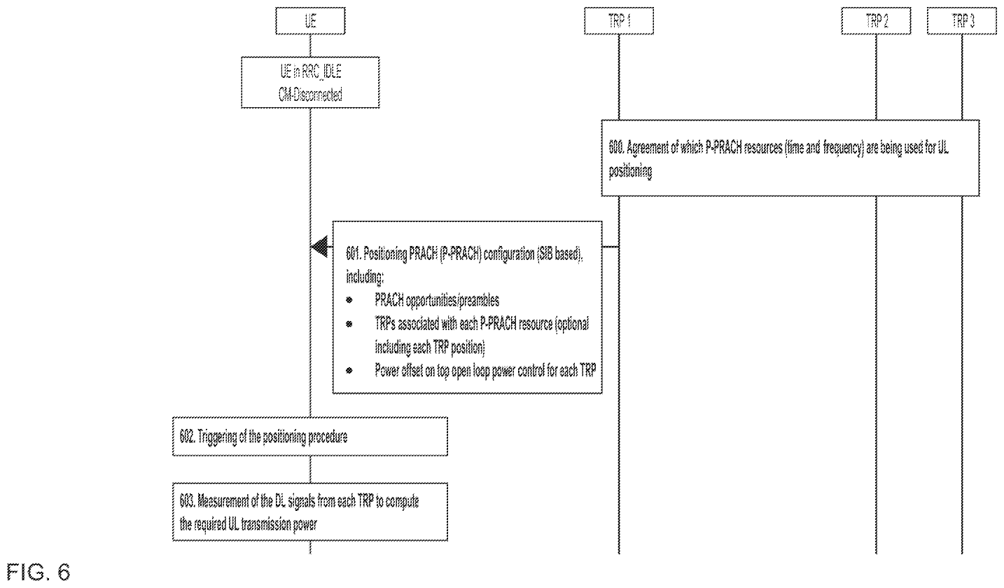

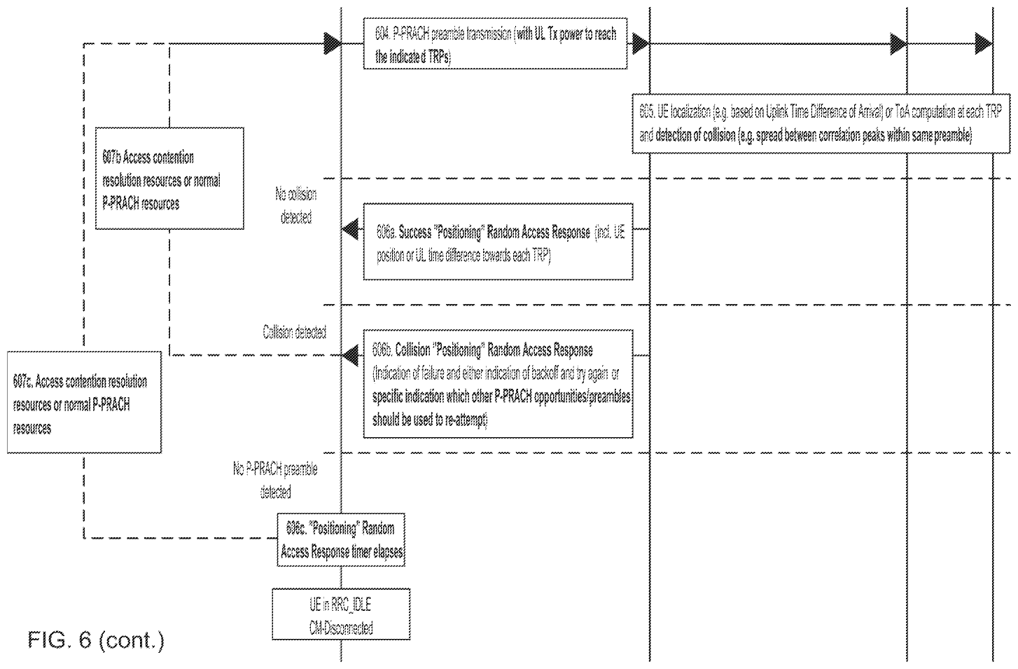

FIG. 6 illustrates two embodiments of a contention-based procedure for uplink localization, according to certain embodiments. As shown in FIG. 6, there can be at least two embodiments, labelled for convenience only and not by way of limitation or preference as embodiment 1 and embodiment 2. In embodiment 1, the device can perform the device's P-PRACH preamble transmission and then can receive from the network indication of the device position. In embodiment 2, the device can perform the device's own P-PRACH preamble transmission and then can receive from the network information about the positioning measurements. The information can be, for example, time and/or angle of arrival at one or more TRP. The device can then use this information to derive the device's own position.

At 600, the TRPs can agree on common PRACH resources and select individual spatial resources to be used for positioning purposes (P-PRACH). This agreement can be made directly between the TRPs or it can be mediated/triggered by a core network entity as the LMF. The agreement can pertain to the TRPs in a given area to be aware of the time and frequency resources of the P-PRACH. The agreement can also include an agreement as to configuration of the associated Zadoff-Chu sequence (or Gold code), the root sequences used, and the number of cyclic shifts per preamble. At least one preamble may have enough cyclic shifts to account for the potential propagation range between the device and any involved TRP.

The agreement can additionally cover the exchange of at least one TRP position (for embodiment 1 and embodiment 2), in case one of the TRPs has to perform the localization or this information needs to be shared with the devices. Alternatively, in case it is the core network LMF (or an edge LMF) performing the positioning, then the TRPs positioning information may already be known by the LMF.

The agreement can also address the selection of common resources, which may be based on a coarse UE location obtained via the most recent serving cell measurements, such as beam index, TA, channel state information (CSI), signal to noise ratio (SNR), reference signal received power (RSRP), or the like.

At least one TRP can also select a list of beams that are likely to point in the direction of the UE. The list may contain at least one index. The dimension of the list can be decided at the TRP level based on the positioning latency requirements for the target UE. For example, since at least one TRP may know at least the signal detection time per beam, the beam switch time, the TRP's own total number of beams, and the latency requirement for the UE, the TRP may decide how many receive beams the TRP can use to scan the angular space so that the P-PRACH is detected before the latency timer expires. Alternatively, the beam information may be sent to the LMF, where the beam selection may happen for some or all TRPs at once, in a centralized manner. The LMF can then inform the TRPs about a preferred beam index list.

At 601, the TRPs can share the P-PRACH information with the devices camped within their coverage. The shared information can include P-PRACH opportunities/preambles. In principle, the preambles within the PRACH opportunities can be shared between positioning and normal RACH operation (e.g. CFRA preambles and CBRA group A and B preambles for both/either 4-step and/or 2-step RACH). The shared information can also include identification of the TRPs that are going be the receivers of the P-PRACH transmission, optionally including their position in case the positioning is computed at the UE, as in embodiment 2).

The shared information can further include power offset to be used on the open loop power control, when the device is determining which transmission power level to use when transmitting the P-PRACH. The shared information can additionally include power ramping step to be used in subsequent positioning attempts when a “Positioning” Random Access Response timer elapses.

As not all involved TRPs need to successfully receive the P-PRACH for obtaining a position estimate, for embodiment 1 the UE position can be calculated at the network side. If the position is accurate enough there may be no need to power ramp and the UE can be prevented from performing power ramping by receiving the feedback from the network. If the position is not accurate enough, the TRP can simply not deliver the result to UE or in an alternative implementation can indicate for the UE to re-attempt the P-PRACH transmission with higher power, such as to perform power ramping. For embodiment 2, the UE may evaluate the quality of the received measurement data directly and decide whether to perform another positioning attempt with higher transmission power if power headroom allows.

The shared information can also include the amount of time expected to be taken to collect, and in case of embodiment 1 to compute, the positioning related information.

At 602, the UE can be triggered to initiate the P-PRACH positioning procedure. As mentioned above, the triggering can be internal to the UE application, such as an aperiodic or periodic polling of positioning data by the application layer and/or by network triggered by, for example, a network paging request.

At 603, the device can measure the DL signal being transmitted from at least one identified TRP informed at 601, with the purpose of determining the UE device's UL transmission power when transmitting the P-PRACH. The device can take into account the configured power offset if any and can selects the UE's own power based on the weaker DL signal received from the identified TRPs. In an alternative embodiment, the power control can be done implicitly via selecting a list of TRPs and having the UE transmit at full power. In this way, the TRPs have been selected so that enough of them hear the full-power transmission of the target UE.

At 604, the device can performs the P-PRACH preamble transmission with enough Tx power such that its P-PRACH transmission reaches the TRPs identified in in the information at 601 and according with the measurements and computation at 602. For example, the device may apply open loop power control based on the SSBs received from the identified TRPs. The P-PRACH transmission time instance may follow the DL synchronization of the serving TRP, which may be the TRP with the highest SSB receiving power.

At 605, at least one TRP can receive the transmitted P-PRACH preamble and can compute the associated positioning measurement, such as time/angle/power of arrival information. The serving TRP collects the time of arrival information from the involved TRPs (or the LMF performs this operation). In embodiment 1, the TRP (or a core network entity as the LMF, or edge LMF) performs the positioning computations, in embodiment 2 the time of arrival information is given to the device.

At this point, at least one TRP can check whether the received P-PRACH preamble is a single transmission or multiple overlapped transmissions. This can be accomplished by evaluating the spread and magnitude of the correlation peaks within the cyclic shifts associated with a preamble. In case the dominating peaks are separated by more than a threshold of cyclic shifts, then the TRP can determine the P-PRACH preamble as being the result of multiple transmissions, and consequently that a collision occurred. Alternatively, the TRPs can provide a soft value describing how certain that a P-PRACH preamble is a single or multiple transmissions.

Even when a collision was detected at a TRP, the TRP can still compute the time of arrival associated with the dominant correlation peak, such as the peak with the highest magnitude. The serving TRP (or the LMF) can then collect the indication of whether a collision took place at the different TRPs and can combine such information to make a global decision of whether a collision took place or not.

The determination of which TRP is the serving TRP can be based on the TRP with the lowest time of arrival and that this time of arrival is below the radius associated with the TRP coverage. It is the serving TRP that may provide feedback to the device. When the P-PRACH preamble is not detected at the serving TRP, then the network may not provide any feedback to the device.

At 606, the serving TRP can provide feedback to the UE in the form of a “Positioning” Random Access Response. In order to receive this feedback, the device can monitor the physical downlink control channel (PDCCH) for a period of time, which can be measured with a “Positioning” Random Access Response Timer, for a downlink control information (DCI) scrambled with the “Positioning” random access radio network temporary identifier (RA-RNTI). Similar to the RA-RNTI in 4-step RACH and MsgB RNTI in 2-step RACH, the positioning RA-RNTI can indicate which resource was used to transmit the P-PRACH preamble.

When no collision was detected and the P-PRACH preamble was detected by the serving TRP, then at 606a the serving TRP can transmit a Success “Positioning” Random Access Response. In embodiment 1, the payload of this message can include the identification of the P-PRACH preamble as well as the device position. In embodiment 2, the payload of this message, besides the identification of the P-PRACH preamble, includes the time of arrival as measured at one or more TRP as well as the indication of which TRP measured it (this can be in the form of an ID or implicitly from the ordering of the time of arrival which can then be mapped to the TRP position information acquired in step 1). At this point the device can be considered to have acquired the device's own position.

When a collision was detected and the P-PRACH preamble was detected by the serving TRP, then at 606b the serving TRP can transmit a collision “Positioning” Random Access Response. This besides identifying the P-PRACH preamble can also indicate that either the device should backoff and attempt the positioning at a later time or it can indicate “special” P-PRACH resources to be used for contention resolution.

When the P-PRACH preamble was not detected by the serving TRP, then at 606c the “Positioning” Random Access Response timer elapses and the device can attempt a retransmission at a later time.

In the case of embodiment 1 and 2, there may be a latency penalty on the collection of the ToA from at least one TRP at either the serving TRP or at the LMF. As this latency can be known in advance by the network and informed to the device, then the device can wait the corresponding x ms (or number of symbols) before starting to listen to the PDCCH.

When positioning was not successful initially, the device can re-attempt the positioning procedure. In case of backoff indicated in a Collision “Positioning” Random Access Response message, the device can re-attempt 604 without increasing its transmission power, for example without using any power ramping. At 607b, when there is indication to access “special” P-PRACH resources to be used for contention resolution, then the device can select a preamble in the indicated resources and transmit the preamble. At 607c, when the “Positioning” Random Access Response timer has elapsed, then the device can reattempt 604 while increasing its transmission power according to the configured power ramping step, if the UE's remaining power headroom allows for such increase.

In certain embodiments, when the network detects that a collision has taken place in a specific P-PRACH preamble in the Contention Based Positioning (CBP), the network can inform the affected devices of the occurrence of a collision and then can assign these devices to Restricted Contention Based Positioning (RCBP) resources. The RCBP resources can be dedicated to serve collided devices. For example, normal accessing devices may not have direct access to these resources. These RCBP resources can be activated by the network on demand, for example, whenever a collision is detected or even to provide certain UEs/application priority in terms of reduced latency.

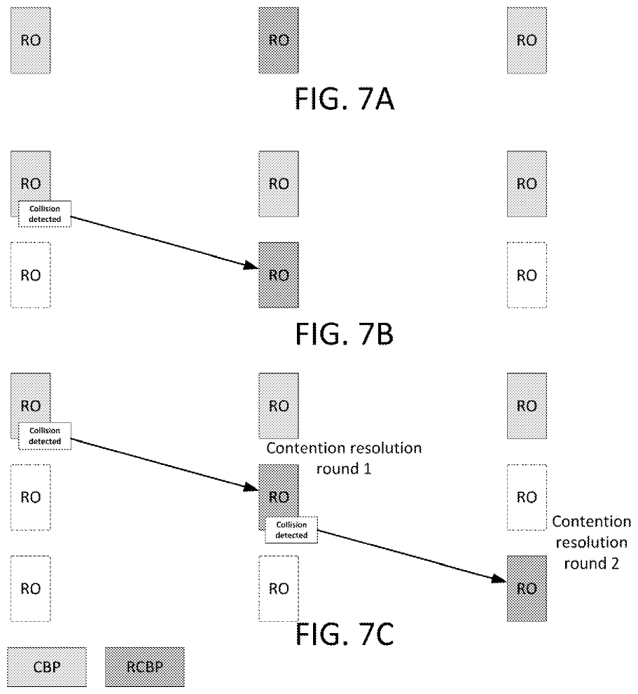

FIGS. 7A, 7B, and 7C illustrates assignment of restricted contention based access resources, according to certain embodiments. As shown in these figures, there are several approaches on how to provision the RCBP resources. More particularly, in FIG. 7A RCBP resources can be interleaved with the CBP resources in time. In FIG. 7B RCBP resources can be parallel in frequency with the CBP resources, which may be activated on demand by the network. In FIG. 7C, multiple sequential RCBP resources can be activated on demand based on the result of the initial contention resolution.

Thus, in FIG. 7A is depicted the case where the RCBP resources are interleaved in time. In practice, this may correspond to dedicating within a PRACH configuration index, a set of PRACH time occasions that would be dedicated to serve as RCBP resources. An alternative approach is to have RCBP resources parallel in frequency, which are activated on demand by the network whenever a collision is detected, as depicted in FIG. 7B. As the affected devices are informed directly, then these RCBP resources can be activated when a collision actually occurs.

As another option, the principle of multiple contention resolution rounds can be introduced as depicted in FIG. 7C, where the network would have multiple parallel RCBP resources to resolve collisions that are not resolved in a single contention round. The benefit of this latter approach may be that it allows the network to adapt to different degrees of severity between collisions. For example, when there are large number of devices colliding then the way to resolve them may be to pass them over multiple contention resolution rounds.

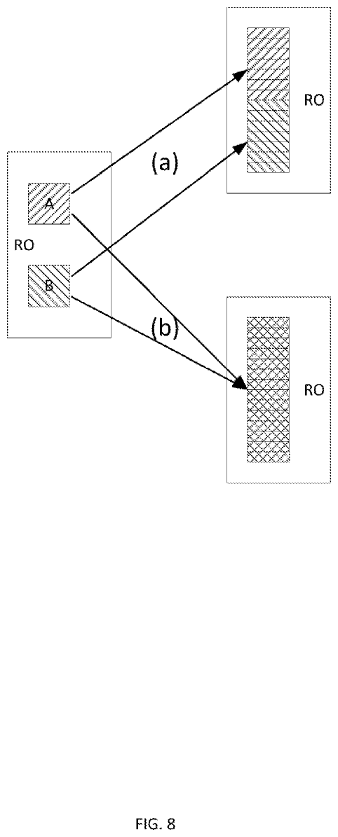

FIG. 8 illustrates example approaches to mapping collided preambles to the resources, according to some embodiments. Thus, in terms of the mapping between collided P-PRACH preambles and the RCBP resources, there are at least two strategies. In a first strategy at branch (a), the collided P-PRACH preambles can be assigned dedicated resources within the RCBP, in order to resolve the collisions between the affected devices. In a second strategy at branch (b), the collided P-PRACH preambles can be assigned common resources within the RCBP, in order to resolve the collisions between the affected devices.

As an illustrating example of the differences between these two strategies, assume that there are four devices transmitting. Two of the devices are transmitting on preamble A, while the other two devices are transmitting on preamble B. In the first strategy, the devices that selected the preamble A are allocated to the upward hashed resources in branch (a), while the devices that selected the preamble B are allocated to the downward hashed resources in branch (a). In the second strategy, the devices that selected the preamble A and the devices that selected the preamble B are allocated to substantially the same double hashed resources as depicted in branch (b).

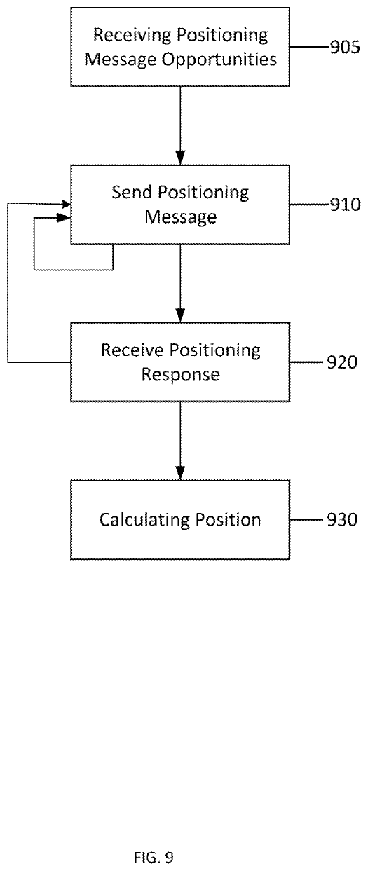

FIG. 9 illustrates an example flow diagram of a method for providing support for contention-based positioning without requiring device authentication, according to certain embodiments. The method of FIG. 9 may provide a way to support recovery of the signal transmitted in the PBCH outside the bandwidth of the UE using a new signal transmitted within the UE bandwidth but in extension symbols outside the existing SSB.

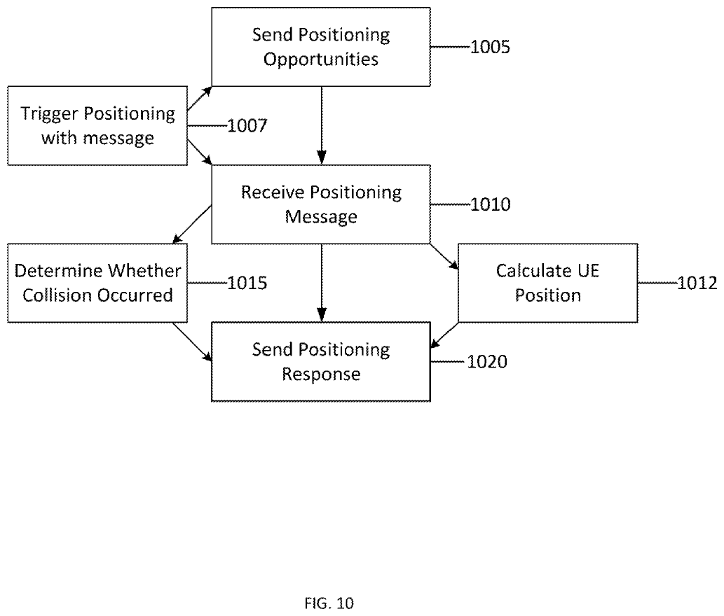

As shown in FIG. 9, a method can include procedures performed by a user equipment. The procedures performed by the user equipment in FIG. 9 can be performed in combination with the procedures performed by the network element in FIG. 10, or separately from one another.

As shown in FIG. 9, a method can include, at 910, sending, by a user equipment, a positioning message to a serving network element in a network that includes a plurality of network elements including both the serving network element itself and at least one other network element. The positioning message can be sent as a contention-based message. For example, the positioning message can be the P-PRACH preamble transmission sent at 605 in FIG. 6 or the P-PRACH preamble transmission sent at 503 in FIG. 5.

The method can also include, at 920, receiving, by the user equipment, a positioning response from the serving network element, wherein content of the positioning response is contingent on a collision result of the contention-based message.

The sending the positioning message at 910 can be triggered by an application of the user equipment. For example, the user equipment may have a location tracking application running thereon, which may be configured to lock or unlock a container based on an identified position. Accordingly, the application may trigger a positioning procedure including the sending of the positioning message.

As another option, the sending the positioning message at 910 can be triggered by a message from the serving network element. Optionally, the message from the serving network element may be processed at an application layer of the user equipment, which may then trigger the user equipment to perform the positioning method.

The receiving the positioning message at 920 can include receiving a position of the user equipment. This may correspond to an embodiment in which the position is calculated by the serving network element or a location management function.

As another option, the method can include, at 930, calculating, by the user equipment, the position of the user equipment from a plurality of values in the positioning message corresponding to the plurality of network elements. In some cases, a large number of nearby network elements may have values, but the user equipment may calculate based on the best network element values. For example, the user equipment may exclude values from non-line-of-sight network elements, in one example.

The content of the positioning response received at 920 may include power ramping instructions, such as to increase power on the positioning message in a subsequent attempt or backoff instructions, such as to transmit at a different opportunity, such as on a reserved resource. For example, the power ramping instructions can include power ramping instructions with respect to power ramping step size per transmission attempt.

The method can additionally include, at 905, receiving, by the user equipment, positioning message opportunities from the serving network element. The sending the positioning message at 910 can involve sending the positioning message during at least one of the positioning message opportunities.

The sending the positioning message to the serving network element at 910 can include sending the positioning message to at least one network element of the plurality of network elements, for example to up to all of the plurality of network elements. A single positioning message can be sent to some or all the network elements, or different positioning messages can be sent individually or in groups. For example, a different transmission power can be used for sending the positioning message to different network elements of the plurality of network elements. In certain embodiments, the device can perform transmission with a single power at a time. This power can be selected via open loop power control against individual targeted TRPs, then the highest power needed for a given TRP can be the one used for that given TRP.

It is noted that FIG. 9 is provided as one example embodiment of a method or process. However, certain embodiments are not limited to this example, and further examples are possible as discussed elsewhere herein.

FIG. 10 illustrates an example flow diagram of a method for providing support for contention-based positioning without requiring device authentication, according to certain embodiments. The procedures performed by the network element in FIG. 10 can be performed in combination with the procedures performed by the user equipment in FIG. 9, or separately from one another.

As shown in FIG. 10, a method can include, at 1010, receiving from a user equipment a positioning message at a serving network element in a network that includes multiple network elements including both the serving network element itself and at least one other network element (see, for example, FIG. 2). The positioning message can be received as a contention-based message, as discussed above with reference to FIG. 9.

The method can also include, at 1020, sending a positioning response from the serving network element. Content of the positioning response can be contingent on a collision result of the contention-based message.

The method can further include, at 1005, sending positioning message opportunities to the user equipment, wherein the receiving the positioning message comprises receiving the positioning message during at least one of the positioning message opportunities.

The method can additionally include, at 1015, determining whether a collision occurred for the positioning message. The content of the positioning response can include backoff instructions when it is determined that a collision occurred. For example, the backoff instructions may indicate that reserved resources should be used, as described above.

The positioning message can be triggered by an application of the user equipment. Alternatively, the method can be triggered by, at 1007, sending a message to the user equipment. The message can be configured to trigger sending the positioning message that is received at 1010. The triggering message can be sent before, after, with, or as the message indicating positioning opportunities.

The sending the positioning message at 1020 can include sending a position of the user equipment. Alternatively, the sending the positioning message at 1020 can include sending values in the positioning message corresponding to the multiple network elements (for example, one value or set of values per network element). A position of the user equipment may be derivable by the user equipment from the plurality of values for example using multilateration or other techniques.

The content of the positioning response sent at 1020 can include power ramping instructions. As mentioned above, the power ramping instructions can include power ramping instructions with respect to power ramping step size per transmission attempt.

The method can also include, at 1012, computing a positioning measurement based on receipt of the positioning message. The computation may be performed at the serving network element, or at another network element, such as a location management function.

The content of the positioning response can include indication of restricted contention based positioning resources for retransmission of the positioning message. It is noted that FIG. 10 is provided as one example embodiment of a method or process. However, certain embodiments are not limited to this example, and further examples are possible as discussed elsewhere herein.

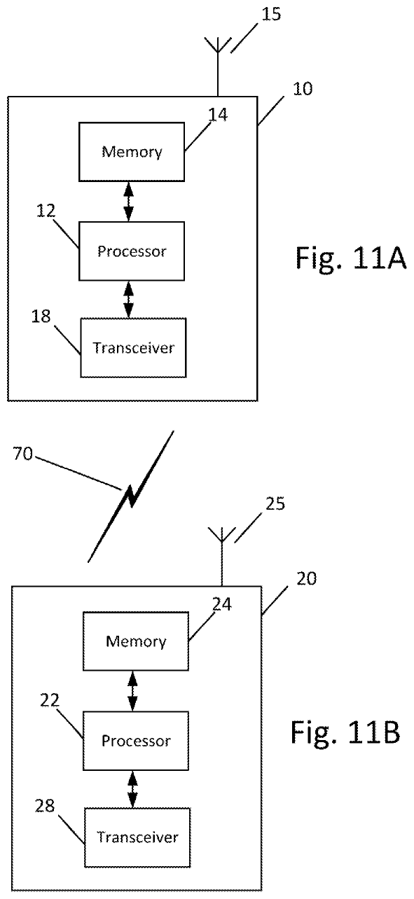

FIG. 11A illustrates an example of an apparatus 10 according to an embodiment. In an embodiment, apparatus 10 may be a node, host, or server in a communications network or serving such a network. For example, apparatus 10 may be a network node, satellite, base station, a Node B, an evolved Node B (eNB), 5G Node B or access point, next generation Node B (NG-NB or gNB), TRP, HAPS, integrated access and backhaul (IAB) node, and/or a WLAN access point, associated with a radio access network, such as a LTE network, 5G or NR. In some example embodiments, apparatus 10 may be gNB or other similar radio node, for instance.

It should be understood that, in some example embodiments, apparatus 10 may comprise an edge cloud server as a distributed computing system where the server and the radio node may be stand-alone apparatuses communicating with each other via a radio path or via a wired connection, or they may be co-located in an entity communicating within the entity via a wired connection. For instance, in certain example embodiments where apparatus 10 represents a gNB, it may be configured in a central unit (CU) and distributed unit (DU) architecture that divides the gNB functionality. In such an architecture, the CU may be a logical node that includes gNB functions such as transfer of user data, mobility control, radio access network sharing, positioning, and/or session management, etc. The CU may control the operation of DU(s) over a front-haul interface. The DU may be a logical node that includes a subset of the gNB functions, depending on the functional split option. It should be noted that one of ordinary skill in the art would understand that apparatus 10 may include components or features not shown in FIG. 11A.

As illustrated in the example of FIG. 11A, apparatus 10 may include a processor 12 for processing information and executing instructions or operations. Processor 12 may be any type of general or specific purpose processor. In fact, processor 12 may include one or more of general-purpose computers, special purpose computers, microprocessors, digital signal processors (DSPs), field-programmable gate arrays (FPGAs), application-specific integrated circuits (ASICs), and processors based on a multi-core processor architecture, or any other processing means, as examples. While a single processor 12 is shown in FIG. 11A, multiple processors may be utilized according to other embodiments. For example, it should be understood that, in certain embodiments, apparatus 10 may include two or more processors that may form a multiprocessor system (e.g., in this case processor 12 may represent a multiprocessor) that may support multiprocessing. In certain embodiments, the multiprocessor system may be tightly coupled or loosely coupled (e.g., to form a computer cluster).

Processor 12 may perform functions associated with the operation of apparatus 10, which may include, for example, precoding of antenna gain/phase parameters, encoding and decoding of individual bits forming a communication message, formatting of information, and overall control of the apparatus 10, including processes related to management of communication or communication resources.

Apparatus 10 may further include or be coupled to a memory 14 (internal or external), which may be coupled to processor 12, for storing information and instructions that may be executed by processor 12. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 14 can be comprised of any combination of random access memory (RAM), read only memory (ROM), static storage such as a magnetic or optical disk, hard disk drive (HDD), or any other type of non-transitory machine or computer readable media, or other appropriate storing means. The instructions stored in memory 14 may include program instructions or computer program code that, when executed by processor 12, enable the apparatus 10 to perform tasks as described herein.

In an embodiment, apparatus 10 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 12 and/or apparatus 10.

In some embodiments, apparatus 10 may also include or be coupled to one or more antennas 15 for transmitting and receiving signals and/or data to and from apparatus 10. Apparatus 10 may further include or be coupled to a transceiver 18 configured to transmit and receive information. The transceiver 18 may include, for example, a plurality of radio interfaces that may be coupled to the antenna(s) 15, or may include any other appropriate transceiving means. The radio interfaces may correspond to a plurality of radio access technologies including one or more of global system for mobile communications (GSM), narrow band Internet of Things (NB-IoT), LTE, 5G, WLAN, Bluetooth (BT), Bluetooth Low Energy (BT-LE), near-field communication (NFC), radio frequency identifier (RFID), ultrawideband (UWB), MulteFire, and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (via an uplink, for example).

As such, transceiver 18 may be configured to modulate information on to a carrier waveform for transmission by the antenna(s) 15 and demodulate information received via the antenna(s) 15 for further processing by other elements of apparatus 10. In other embodiments, transceiver 18 may be capable of transmitting and receiving signals or data directly. Additionally or alternatively, in some embodiments, apparatus 10 may include an input and/or output device (I/O device), or an input/output means.

In an embodiment, memory 14 may store software modules that provide functionality when executed by processor 12. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

According to some embodiments, processor 12 and memory 14 may be included in or may form a part of processing circuitry/means or control circuitry/means. In addition, in some embodiments, transceiver 18 may be included in or may form a part of transceiver circuitry/means.

As used herein, the term “circuitry” may refer to hardware-only circuitry implementations (e.g., analog and/or digital circuitry), combinations of hardware circuits and software, combinations of analog and/or digital hardware circuits with software/firmware, any portions of hardware processor(s) with software (including digital signal processors) that work together to cause an apparatus (e.g., apparatus 10) to perform various functions, and/or hardware circuit(s) and/or processor(s), or portions thereof, that use software for operation but where the software may not be present when it is not needed for operation. As a further example, as used herein, the term “circuitry” may also cover an implementation of merely a hardware circuit or processor (or multiple processors), or portion of a hardware circuit or processor, and its accompanying software and/or firmware. The term circuitry may also cover, for example, a baseband integrated circuit in a server, cellular network node or device, or other computing or network device.

As introduced above, in certain embodiments, apparatus 10 may be or may be a part of a network element or RAN node, such as a base station, access point, Node B, eNB, gNB, TRP, HAPS, IAB node, relay node, WLAN access point, satellite, or the like. In one example embodiment, apparatus 10 may be a gNB or other radio node, or may be a CU and/or DU of a gNB. According to certain embodiments, apparatus 10 may be controlled by memory 14 and processor 12 to perform the functions associated with any of the embodiments described herein. For example, in some embodiments, apparatus 10 may be configured to perform one or more of the processes depicted in any of the flow charts or signaling diagrams described herein, such as those illustrated in FIGS. 1-10, or any other method described herein. In some embodiments, as discussed herein, apparatus 10 may be configured to perform a procedure relating to providing support for contention-based positioning without requiring device authentication, for example.

FIG. 11B illustrates an example of an apparatus 20 according to another embodiment. In an embodiment, apparatus 20 may be a node or element in a communications network or associated with such a network, such as a UE, communication node, mobile equipment (ME), mobile station, mobile device, stationary device, IoT device, or other device. As described herein, a UE may alternatively be referred to as, for example, a mobile station, mobile equipment, mobile unit, mobile device, user device, subscriber station, wireless terminal, tablet, smart phone, IoT device, sensor or NB-IoT device, a watch or other wearable, a head-mounted display (HMD), a vehicle, a drone, a medical device and applications thereof (e.g., remote surgery), an industrial device and applications thereof (e.g., a robot and/or other wireless devices operating in an industrial and/or an automated processing chain context), a consumer electronics device, a device operating on commercial and/or industrial wireless networks, or the like. As one example, apparatus 20 may be implemented in, for instance, a wireless handheld device, a wireless plug-in accessory, or the like.

In some example embodiments, apparatus 20 may include one or more processors, one or more computer-readable storage medium (for example, memory, storage, or the like), one or more radio access components (for example, a modem, a transceiver, or the like), and/or a user interface. In some embodiments, apparatus 20 may be configured to operate using one or more radio access technologies, such as GSM, LTE, LTE-A, NR, 5G, WLAN, WiFi, NB-IoT, Bluetooth, NFC, MulteFire, and/or any other radio access technologies. It should be noted that one of ordinary skill in the art would understand that apparatus 20 may include components or features not shown in FIG. 11B.

As illustrated in the example of FIG. 11B, apparatus 20 may include or be coupled to a processor 22 for processing information and executing instructions or operations. Processor 22 may be any type of general or specific purpose processor. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. While a single processor 22 is shown in FIG. 11B, multiple processors may be utilized according to other embodiments. For example, it should be understood that, in certain embodiments, apparatus 20 may include two or more processors that may form a multiprocessor system (e.g., in this case processor 22 may represent a multiprocessor) that may support multiprocessing. In certain embodiments, the multiprocessor system may be tightly coupled or loosely coupled (e.g., to form a computer cluster).

Processor 22 may perform functions associated with the operation of apparatus 20 including, as some examples, precoding of antenna gain/phase parameters, encoding and decoding of individual bits forming a communication message, formatting of information, and overall control of the apparatus 20, including processes related to management of communication resources.

Apparatus 20 may further include or be coupled to a memory 24 (internal or external), which may be coupled to processor 22, for storing information and instructions that may be executed by processor 22. Memory 24 may be one or more memories and of any type suitable to the local application environment, and may be implemented using any suitable volatile or nonvolatile data storage technology such as a semiconductor-based memory device, a magnetic memory device and system, an optical memory device and system, fixed memory, and/or removable memory. For example, memory 24 can be comprised of any combination of random access memory (RAM), read only memory (ROM), static storage such as a magnetic or optical disk, hard disk drive (HDD), or any other type of non-transitory machine or computer readable media. The instructions stored in memory 24 may include program instructions or computer program code that, when executed by processor 22, enable the apparatus 20 to perform tasks as described herein.

In an embodiment, apparatus 20 may further include or be coupled to (internal or external) a drive or port that is configured to accept and read an external computer readable storage medium, such as an optical disc, USB drive, flash drive, or any other storage medium. For example, the external computer readable storage medium may store a computer program or software for execution by processor 22 and/or apparatus 20.

In some embodiments, apparatus 20 may also include or be coupled to one or more antennas 25 for receiving a downlink signal and for transmitting via an uplink from apparatus 20. Apparatus 20 may further include a transceiver 28 configured to transmit and receive information. The transceiver 28 may also include a radio interface (e.g., a modem) coupled to the antenna 25. The radio interface may correspond to a plurality of radio access technologies including one or more of GSM, LTE, LTE-A, 5G, NR, WLAN, NB-IoT, Bluetooth, BT-LE, NFC, RFID, UWB, and the like. The radio interface may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink.

For instance, transceiver 28 may be configured to modulate information on to a carrier waveform for transmission by the antenna(s) 25 and demodulate information received via the antenna(s) 25 for further processing by other elements of apparatus 20. In other embodiments, transceiver 28 may be capable of transmitting and receiving signals or data directly. Additionally or alternatively, in some embodiments, apparatus 20 may include an input and/or output device (I/O device). In certain embodiments, apparatus 20 may further include a user interface, such as a graphical user interface or touchscreen.

In an embodiment, memory 24 stores software modules that provide functionality when executed by processor 22. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software. According to an example embodiment, apparatus 20 may optionally be configured to communicate with apparatus 10 via a wireless or wired communications link 70 according to any radio access technology, such as NR.

According to some embodiments, processor 22 and memory 24 may be included in or may form a part of processing circuitry or control circuitry. In addition, in some embodiments, transceiver 28 may be included in or may form a part of transceiving circuitry.

As discussed above, according to some embodiments, apparatus 20 may be a UE, SL UE, relay UE, mobile device, mobile station, ME, IoT device and/or NB-IoT device, or the like, for example. According to certain embodiments, apparatus 20 may be controlled by memory 24 and processor 22 to perform the functions associated with any of the embodiments described herein, such as one or more of the operations illustrated in, or described with respect to, FIGS. 1-10, or any other method described herein. For example, in an embodiment, apparatus 20 may be controlled to perform a process relating to providing support for contention-based positioning without requiring device authentication, as described in detail elsewhere herein.

In some embodiments, an apparatus (e.g., apparatus 10 and/or apparatus 20) may include means for performing a method, a process, or any of the variants discussed herein. Examples of the means may include one or more processors, memory, controllers, transmitters, receivers, and/or computer program code for causing the performance of any of the operations discussed herein.

In view of the foregoing, certain example embodiments provide several technological improvements, enhancements, and/or advantages over existing technological processes and constitute an improvement at least to the technological field of wireless network control and/or management. Certain embodiments may have various benefits and advantages. For example, the network may have much more control of collision probability. For example, devices attempting contention based positioning at substantially the same time and colliding over substantially the same resources may need to perform their retransmission(s) here. With certain embodiments, the collision probability may be much lower as other devices, which are not under gNB control, might still attempt their contention based positioning over the CBP resources. The RCBP resources, in case they are not needed, may still be available for the network to schedule normal UL transmissions on these resources in case there are no collisions or retransmissions needed.

Additionally, certain embodiments may be applicable to various devices including without limitation devices in RRC idle and inactive state. Certain embodiments can avoid the need for the device to authenticate itself to the network. Furthermore certain embodiments may provide a mechanism to resolve collision, when two or more devices select the conflicting P-PRACH preambles, such as where the preamble of one of the devices is indistinguishable from the preamble of the other device.

In some example embodiments, the functionality of any of the methods, processes, signaling diagrams, algorithms or flow charts described herein may be implemented by software and/or computer program code or portions of code stored in memory or other computer readable or tangible media, and may be executed by a processor.

In some example embodiments, an apparatus may include or be associated with at least one software application, module, unit or entity configured as arithmetic operation(s), or as a program or portions of programs (including an added or updated software routine), which may be executed by at least one operation processor or controller. Programs, also called program products or computer programs, including software routines, applets and macros, may be stored in any apparatus-readable data storage medium and may include program instructions to perform particular tasks. A computer program product may include one or more computer-executable components which, when the program is run, are configured to carry out some example embodiments. The one or more computer-executable components may be at least one software code or portions of code. Modifications and configurations needed for implementing the functionality of an example embodiment may be performed as routine(s), which may be implemented as added or updated software routine(s). In one example, software routine(s) may be downloaded into the apparatus.

As an example, software or computer program code or portions of code may be in source code form, object code form, or in some intermediate form, and may be stored in some sort of carrier, distribution medium, or computer readable medium, which may be any entity or device capable of carrying the program. Such carriers may include a record medium, computer memory, read-only memory, photoelectrical and/or electrical carrier signal, telecommunications signal, and/or software distribution package, for example. Depending on the processing power needed, the computer program may be executed in a single electronic digital computer or it may be distributed amongst a number of computers. The computer readable medium or computer readable storage medium may be a non-transitory medium.

In other example embodiments, the functionality of example embodiments may be performed by hardware or circuitry included in an apparatus, for example through the use of an application specific integrated circuit (ASIC), a programmable gate array (PGA), a field programmable gate array (FPGA), or any other combination of hardware and software. In yet another example embodiment, the functionality of example embodiments may be implemented as a signal, such as a non-tangible means, that can be carried by an electromagnetic signal downloaded from the Internet or other network.

According to an example embodiment, an apparatus, such as a node, device, or a corresponding component, may be configured as circuitry, a computer or a microprocessor, such as single-chip computer element, or as a chipset, which may include at least a memory for providing storage capacity used for arithmetic operation(s) and/or an operation processor for executing the arithmetic operation(s).

Example embodiments described herein may apply to both singular and plural implementations, regardless of whether singular or plural language is used in connection with describing certain embodiments. For example, an embodiment that describes operations of a single network node may also apply to example embodiments that include multiple instances of the network node, and vice versa.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

### LIST OF ABBREVIATIONS

CBP Contention Based Positioning
DCI Downlink Control Information
LMF Location Management Function
PDCCH Physical Downlink Control Channel
PRACH Physical Random Access Channel
P-PRACH Positioning PRACH
RA-RNTI Random Access RNTI
RACH Random Access Channel
RCBP Restricted Contention Based Positioning
RNTI Radio Network Temporary Identifier
ToA Time of Arrival
TRP Transmission/Reception Point
UE User Equipment

1-63. (canceled)

64. An apparatus, comprising:
at least one processor; and
at least one memory including computer program instructions,
wherein the at least one memory and computer program instructions are configured to, with the at least one processor, cause the apparatus at least to perform:
sending a positioning message to a serving network element in a network comprising a plurality of network elements comprising the serving network element and at least one other network element, wherein the positioning message is sent as a contention-based message; and
receiving a positioning response from the serving network element.

65. The apparatus of claim 64, wherein content of the positioning response is contingent on a collision result of the contention-based message.

66. The apparatus of claim 64, wherein the sending the positioning message is triggered by an application of the apparatus.

67. The apparatus of claim 64, wherein the sending the positioning message is triggered by a message from the serving network element.

68. The apparatus of claim 64, wherein the receiving the positioning message comprises receiving a position of the apparatus.

69. The apparatus of claim 64, wherein the at least one memory and computer program instructions are further configured to, with the at least one processor, cause the apparatus at least to perform:
calculating the position of the apparatus from a plurality of values in the positioning message corresponding to the plurality of network elements.

70. The apparatus of claim 64, wherein the content of the positioning response comprises power ramping instructions or backoff instructions.

71. The apparatus of claim 64, wherein the at least one memory and computer program instructions are further configured to, with the at least one processor, cause the apparatus at least to perform:
receiving positioning message opportunities from the serving network element, wherein the sending the positioning message comprises sending the positioning message during at least one of the positioning message opportunities.

72. The apparatus of claim 64, wherein the sending the positioning message to the serving network element comprises sending the positioning message to the plurality of network elements.

73. The apparatus of claim 72, wherein a different transmission power is used for sending the positioning message to different network elements of the plurality of network elements.

74. An apparatus, comprising:
at least one processor; and
at least one memory including computer program instructions,
wherein the at least one memory and computer program instructions are configured to, with the at least one processor, cause the apparatus at least to perform:
receiving from a user equipment a positioning message at a serving network element in a network comprising a plurality of network elements comprising the serving network element and at least one other network element, wherein the positioning message is received as a contention-based message; and
sending a positioning response from the serving network element.

75. The apparatus of claim 74, wherein content of the positioning response is contingent on a collision result of the contention-based message.

76. The apparatus of claim 74, wherein the at least one memory and computer program instructions are further configured to, with the at least one processor, cause the apparatus at least to perform:
sending positioning message opportunities to the user equipment, wherein the receiving the positioning message comprises receiving the positioning message during at least one of the positioning message opportunities.

77. The apparatus of claim 74, wherein the at least one memory and computer program instructions are further configured to, with the at least one processor, cause the apparatus at least to perform:
determining whether a collision occurred for the positioning message, wherein the content of the positioning response comprises backoff instructions when it is determined that a collision occurred.

78. The apparatus of claim 74, wherein the at least one memory and computer program instructions are further configured to, with the at least one processor, cause the apparatus at least to perform:
sending a message to the user equipment, wherein the message is configured to trigger sending the positioning message.

79. The apparatus of claim 74, wherein the sending the positioning message comprises sending a position of the user equipment.

80. The apparatus of claim 74, wherein the sending the positioning message comprises sending a plurality of values in the positioning message corresponding to the plurality of network elements, wherein a position of the user equipment is derivable by the user equipment from the plurality of values.

81. The apparatus of claim 74, wherein the content of the positioning response comprises power ramping instructions, wherein the power ramping instructions comprise power ramping instructions with respect to power ramping step size per transmission attempt.

82. The apparatus of claim 74, wherein the at least one memory and computer program instructions are further configured to, with the at least one processor, cause the apparatus at least to perform:
computing a positioning measurement based on receipt of the positioning message.

83. The apparatus of claim 74, wherein the content of the positioning response comprises indication of restricted contention based positioning resources for retransmission of the positioning message.
